(19) United States
(12) Patent Application Publication
(10) Pub. No.: US 2006/0176170 A1
(43) Pub. Date: Aug. 10, 2006

(54) Data extraction and processing systems and methods

(76) Inventor: Wesley C. Adams, Bath, ME (US)

Correspondence Address: SUTHERLAND ASBILL & BRENNAN LLP, 999 PEACHTREE STREET, N.E., ATLANTA, GA, 30309, US

(21) Appl. No.: 11/329,309

(22) Filed: Jan. 10, 2006

Related U.S. Application Data
(60) Provisional application No. 60/642,599, filed on Jan. 10, 2005.

(51) Int. Cl. G08B 19/00; G08B 1/00

(52) U.S. Cl. 340/521; 340/531

(57) ABSTRACT

Data extraction and processing systems and methods for extracting security tour data collected by tour guards and stored in local security systems for delivery to a central monitoring center. Collected security tour data is periodically checked to determine if it previously has been sent to the central monitoring center, and if it hasn't then the security tour data is prepared and sent to the central monitoring center. As new data extraction routines are become available, they are automatically identified by the local security systems and downloaded. Once downloaded, the current data extraction routines are replaced with the new data extraction routine.

### RELATED APPLICATION DATA

The present application claims the benefit of U.S. Provisional Patent Application Ser. No. 60/642,599 filed Jan. 10, 2005, titled “Data Extraction and Processing Systems and Methods,” which is hereby incorporated by reference as if set forth fully herein.

### FIELD OF THE INVENTION

This invention relates to security systems, and more particularly, to automatically extracting data from security systems to allow for centralized monitoring of security guard tours.

### BACKGROUND OF THE INVENTION

It is well known and quite common for commercial and industrial premises to be protected by security companies providing on-site security guards as a service. A security company typically employs guards, which are assigned to patrol the premises of the customers of the security company. To ensure that the premises are protected, each guard is responsible for thoroughly and regularly patrolling all or part of the premises. The security company will specify a “tour” to be completed by a particular guard at predetermined intervals. A tour comprises a number of checkpoints located along a predefined route. While completing a tour, a guard inspects the customer's property, checking the security of doors and windows, and looking for intruders or other unauthorized activity. In addition, guards take note of situations that may tangentially affect security, including maintenance problems such as lighting fixture failures. To verify completion of each tour, a guard may be required to record the status of the premises at each checkpoint.

The tour record can be created manually, such as by writing entries into a log book, which is subsequently submitted to the security company. Electronic tour tracking systems automate the process of logging the tour. With an exemplary electronic tour tracking system (ETTS), a guard touches a wand to a button fixed at each checkpoint, thereby creating an electronic record of the date and time that the checkpoint was toured. The record is stored in the wand until the guard uses a docking station where a means for extracting the electronic record from the wand uploads the information to a central monitoring center (CMC) which may be located on or off the customer premises.

If the guard encounters any condition or event that should be brought to the attention of the security company and/or customer, the guard may be able to enter additional information into the wand. The additional information is entered using a keypad, or a portable set of buttons to which the guard can touch on the wand. Each of the portable set of buttons corresponds to a different condition or event, such as “broken lock” or “theft detected.” When the data from the wand is extracted and uploaded, an exception is generated, which may appear as an icon alarm or other alert mechanism at the CMC.

CMC operators typically simultaneously monitor more than one customer site in more than one geographic location, and potentially all of the customers served by the security company. When the customer sites do not include the latest software upgrade and/or are not generally compatible with the CMC systems, then data can be lost or corrupted and sometimes without the CMC operator knowing that there is a problem with the uploaded information.

In addition, upgrading software dedicated to uploading data from a local security system can be an inefficient and costly process. In many cases different customer sites run different software. As a result, the software upgrading process has to be customized to be compatible for each customer site and has to be done locally at each individual customer site. Due to the costly nature of such a process, software upgrading is not done as frequently as it should be for a number of customer sites. Often to save costs, the installation of software upgrades at customer sites are done by untrained or inadequately trained personnel. As a result, many software upgrades are inadequately completed or not completed at all. This adds to the delay of having the upgraded software on-line with the rest of a security monitoring system, which can cripple the monitoring of a remote customer site. All these factors add to the inefficiency and cost of maintaining a software system for uploading data from a local security system. Thus, a need exists for a more efficient and reliable system for uploading data from a local security system.

### SUMMARY OF THE INVENTION

The present invention comprises data extraction and processing systems and methods for extracting security tour data collected by tour guards and stored in local security systems for delivery to a central monitoring center. Security tour data is collected locally by a security system and periodically checked to determine if it has previously been sent to a central monitoring center, and if it hasn't then that security tour data is prepared and sent to the central monitoring center. As new data extraction routines are become available, they are automatically identified by the local security systems and downloaded. Once downloaded, the current data extraction routine is replaced with the new data extraction routine.

### DESCRIPTION OF THE FIGURES

FIG. 1 is a block diagram of the data extraction system working in conjunction with a security system in accordance with an exemplary embodiment of the present invention.

FIG. 2 is a flow chart of the data extraction routine in accordance with an exemplary embodiment of the present invention.

FIG. 3 is a flow chart of the data extraction updater in accordance with an exemplary embodiment of the present invention.

FIG. 4 is a flow chart of the data extraction replacer in accordance with an exemplary embodiment of the present invention.

### DESCRIPTION OF INVENTION

The present invention is directed to a software system that automatically can extract newly recorded security information whenever it occurs and upload that information to the CMC (which may or may not be remotely located from where the security information is being electronically recorded) using the same network the CMC is connected to and utilizing simple communication protocols such as FTP. Moreover, the system extracting the recorded security data and uploading it to the CMC is automatically updated and replaced remotely and automatically when new security recording functionality is incorporated into the security system.

The present invention will be described with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Exemplary embodiments of the present invention will hereinafter be described with reference to the figures, in which like numerals indicate like elements throughout the several drawings. The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network. The exemplary embodiments described herein relate to the automated extraction and transmission of guard tour data from a security guard system and to a CMC according to a predefined periodic time interval, where the extracting system is self-updating and can be integrated into standard computer systems, rather than require its own dedicated server.

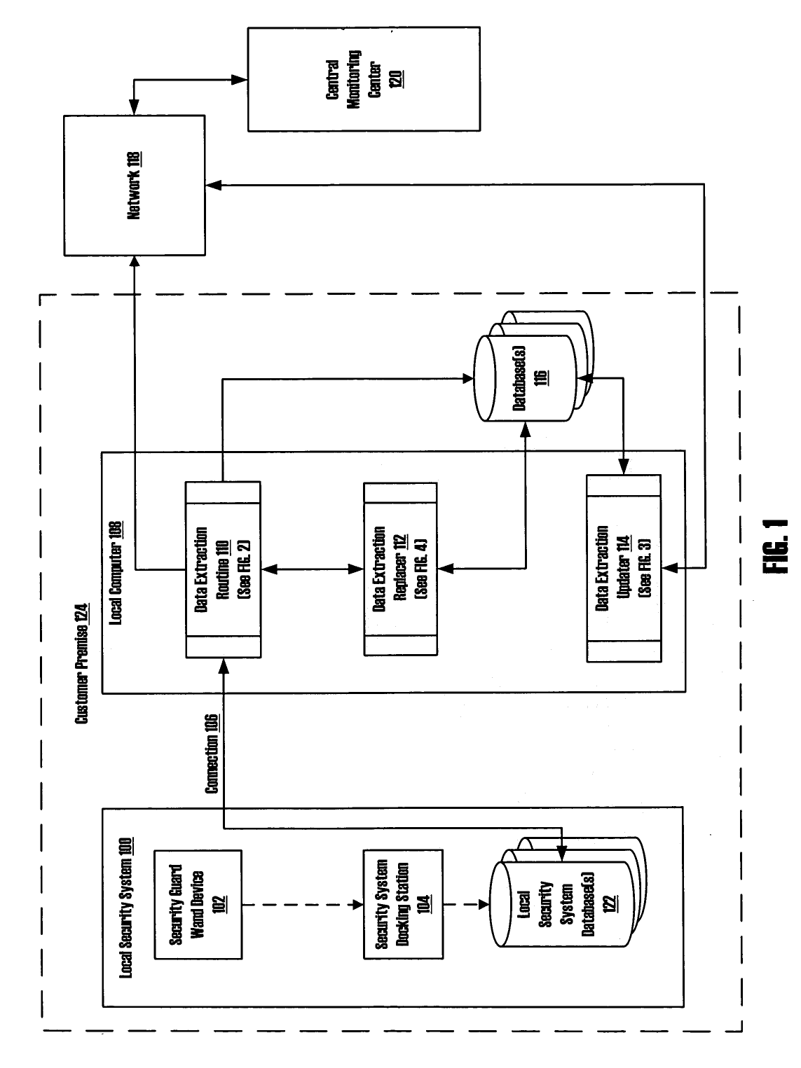

FIG. 1 shows a block diagram of a customer premise 124 connected through a network 118 to a CMC 120. Integrated into the customer premise 124 is the data extraction system implemented on a local computer 108 working in conjunction with a local security system 100, in accordance with an exemplary embodiment of the present invention. The local security system 100 may comprise a security guard wand device 102 that communicates security guard tour data (or any other data capable of being logged) with a security system docking station 104 (also known as a cradle) and a memory storage device, which in FIG. 1 is referred to as the local security system database 122. The local security system database 122 stores the data that is sent from the security guard wand device 102 to the security system docking station 104. The local computer 108 contains the typical components of a computer such as a processor, operating system, I/O interfaces, memory devices, etc. In addition, the local computer 108 operates the data extraction software system, which in the illustrative embodiment of the present invention comprises three software routines stored in the local computers memory or an associated database 116.

The three software routines include a data extraction routine 110, a data extraction replacer 112 and a data extraction updater 114. In an exemplary embodiment of the present invention the software routines are implemented in Visual Basic 6 and run on the Microsoft Windows operating system on the local computer 108, however, one of ordinary skill in the art can appreciate implementing the same functionality of the present invention in a number of comparable software languages (e.g., C++, Java, etc.) and various operating systems (e.g., Linux, DOS, Unix).

The local computer 108 of the customer premise 124 is connected to a central monitoring device through a network 118. In exemplary embodiments of the present invention, the network 118 may be a WAN, LAN, PSTN, Wireless, or any other type of network appreciable by one of ordinary skill in the art. The network also may support various protocols, such as FTP. In alternative embodiments of the present invention, the local computer 108 may be integrated with the local security system 100. This can be done by integrating the local computer 108 into the security system docking station 104 or portable devices carried by security guards such as the security guard wand devices 102 themselves or other devices such as radios, PDA's, etc. Alternatively, the local computer 108 and the local security system 100 may be remote from each other so as to communicate through a connection 106. The connection 106 may be a local network such as a LAN, WLAN and/or Bluetooth enabled or any other communication means appreciable by one of ordinary skill in the art. Further, in alternative embodiments of the present invention the local computer 108 and local security system may also access the same memory devices (e.g., combine the local security system database 122 and the database 116 as one memory device).

As shown in FIG. 1, the data extraction routine 110 extracts new guard tour data from the local security system 100 over the connection 106 and uploads the guard tour data to a network 118, which sends the data to the central monitoring center (CMC) 120. The data extraction routine 110 periodically checks the local security system database 122 for new guard tour data to extract and send to the CMC 120. New guard tour data is sent to the local security system database 122 whenever a security guard wand device 102 inputs new guard tour data at the security system docking station 104. The data extraction routine 110 also periodically checks a database 116 in (or remote to) a local computer 108 to see if the data extraction updater 114 has retrieved a new updated version of the data extraction routine from the CMC 120. The data extraction updater 114 periodically checks the CMC 120 for any new data extraction routines to download for replacing the current data extraction routine. When one is available the data extraction updater retrieves it and stores it in a database 116. If the data extraction updater 114 has retrieved a new updated version of the data extraction routine, then the data extraction routine 110 abandons checking for new tour data to upload and runs the data extraction replacer 112 to retrieve the new version from the database 116 and replace the current data extraction routine 110 being executed on the local computer 108 with the new updated version.

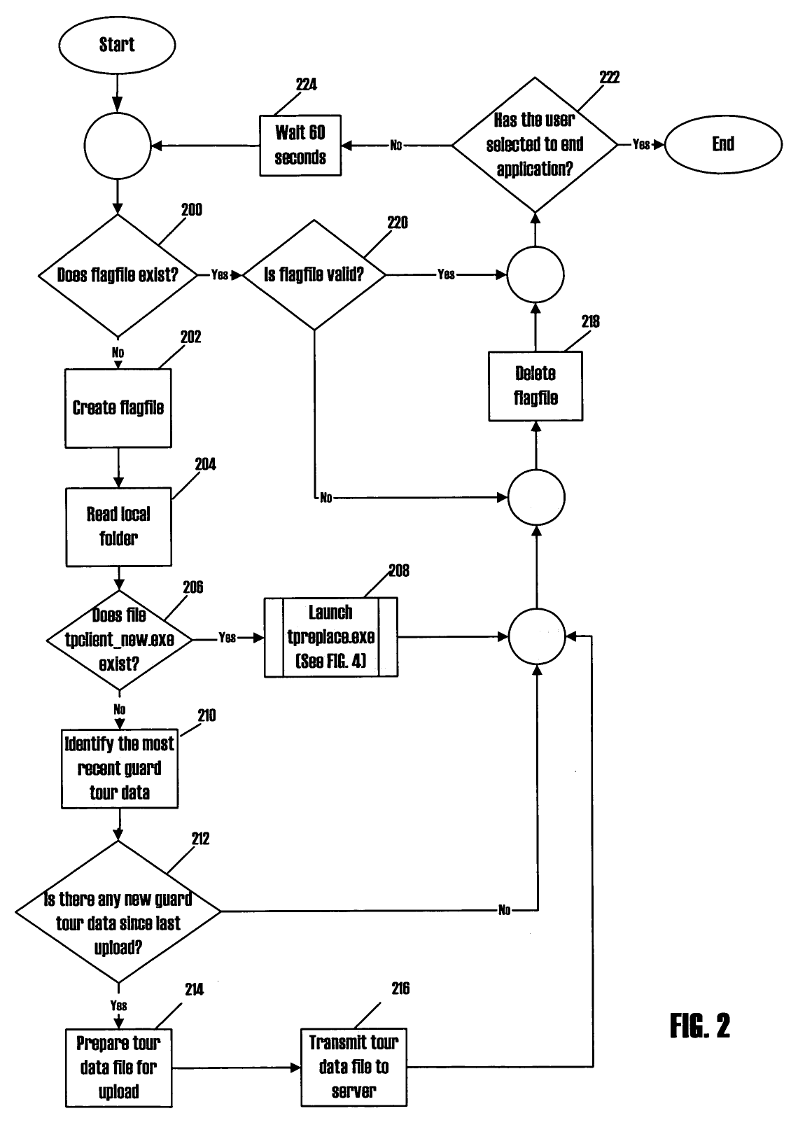

FIG. 2 is a flow chart of the data extraction routine 110 in accordance with an exemplary embodiment of the present invention. In an exemplary embodiment of the present invention, this software routine starts at system startup and may continue to run the entire time the machine is operable. At step 200, the data extraction routine checks if an indicator has been set (e.g., a flag) that indicates if the system is updating or replacing the data extraction software routine or for any other reason that the data extraction should not occur at that moment in time. If an indicator is set, then step 220 is invoked, and the application checks to see if the indicator is false. To do this, step 220 checks, for example, if the indicator has been set for an extended time interval, which may be a predetermined length of time. One of ordinary skill in the art will appreciate that such a time interval can vary in its length, though it is preferable that the time interval is longer than the time it would take to run the update or replace software routines. If the indicator is valid (e.g., it has not been set for a time interval longer than a predetermined interval), then step 222 is invoked to check if the user selected to end the application. If the user did not select that the application should end, then step 224 is taken, and the application waits a predetermined time interval, for example, 60 seconds, before checking again to see if the system is ready for data extraction. Again, one of ordinary skill in the art will appreciate that such a time interval may vary in its length. However, if the indicator is invalid (e.g., it has been set longer than the predetermined time interval), then step 218 is invoked, and the indicator is removed or deleted before step 222 is invoked.

If step 200 determines that no indicator is set, then step 202 is invoked to create one. This ensures that no other data extraction will occur until this routine ends. Next, at step 204, the application checks to see if it needs to be replaced. To do this, a local folder location located in the database 116 is read to check if a new data extraction routine exists (referred to as “tpclient_new.exe” in FIG. 2). If one does exist, then the application invokes step 208 to initiate the data extraction replacer 112 (referred to as tpreplace.exe in FIG. 2), which searches a pre-specified data location in database 116 for an executable file that will cause the data extraction routine 110 to be replaced. One of ordinary skill in the art will appreciate that the local folder location can be varied as well as being accessed locally or remotely.

If no executable file is found, the data extraction routine's next step 210 is to identify the most recently downloaded guard tour data that was downloaded by a security device (e.g., security wand or pen) of the local security system 110 to the guard tour system's database 122 or some other storage location. In an alternative form of the present invention, the guard tour system's database 122 and the database 116 can be located in the same storage device. In an exemplary embodiment of the present invention the guard tour data is stored in the form of a text file, although one of ordinary skill in the art will appreciate the use of other formats of data storage and form.

Next, step 212 is invoked to determine if the identified guard tour data has previously been uploaded to the CMC 120. One of ordinary skill in the art will appreciate that is can be done by time stamping the logged guard tour data or various types of time indicators or flags that are updated and/or included with the guard tour data when it is logged. In the present embodiment, the tour data and the time it was logged is used to determine if the tour data has been previously extracted and uploaded before by the data extraction routine 110. If that guard tour data has been previously extracted and uploaded by the data extractor routine 110, then the application proceeds to step 218, deletes the flag it set, waits a specified time interval, and starts over with the checking the indicator and proceeds with the aforementioned steps.

If the tour data has not been previously uploaded, then step 214 prepares the tour data for upload and step 216 transmits (or uploads) the tour data to the CMC 120. After step 216 is completed the application proceeds to step 218. In an exemplary embodiment of the present invention, the preparing step 214 may be done by automatically creating a formatted text file for each day that has passed since the tour data was last transmitted to a CMC plus one extra day. One of ordinary skill in the art will appreciate that other time intervals than a day may also be used in the preparing step. In a typical operation, only hours pass between each upload, however the system uploads both the current day's data and the prior day's data. This provides a snap-shot of what data has been logged for at least the past 24 hours, and this information can be analyzed in whole or in part at the CMC 120.

In an exemplary embodiment of the present invention, the tour data is transmitted via FTP protocol, however, one of ordinary skill in the art will appreciate various ways of transmitting the same data (e.g., email, fax, LAN, WLAN, dedicated modem, dial-up, Ethernet, etc.). Moreover, one of ordinary skill in the art will appreciate that the CMC can be remote from the system running the data extraction routine or integrated with it. Once the files have been uploaded via FTP, the system waits a specified time interval and the data extraction process starts over.

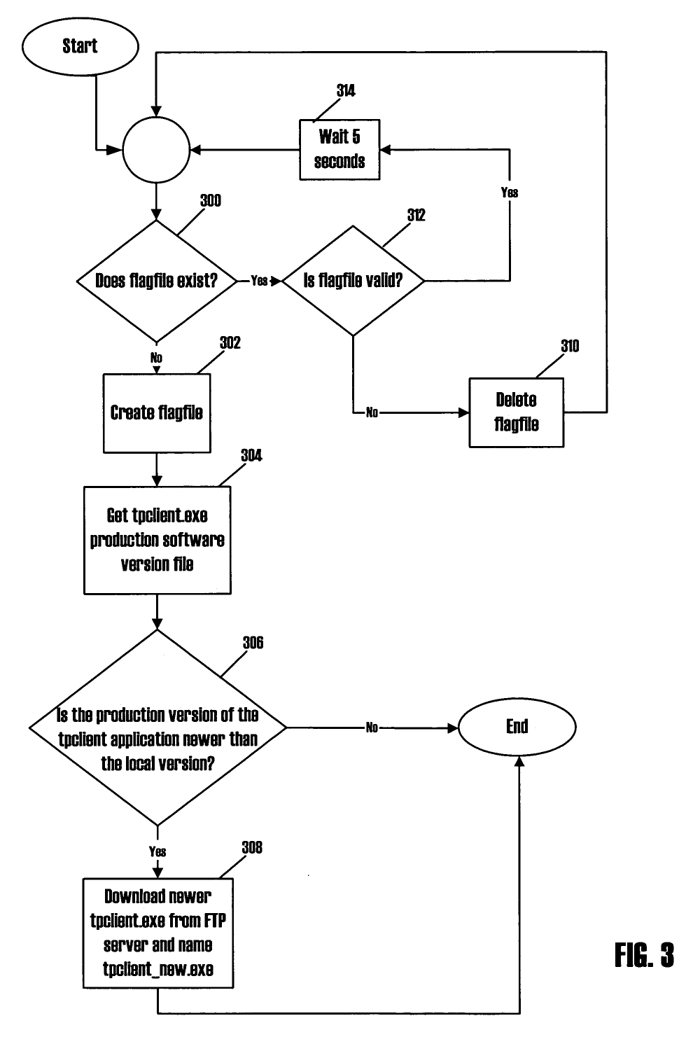

FIG. 3 is a flow chart of the data extraction updater 114 in accordance with an exemplary embodiment of the present invention. In an exemplary embodiment of the present invention, the data extraction updater 114 is an application that runs once during a specified time interval (usually a day) and is started by an operating systems job scheduler located in the local computer 108. When the data extraction updater 114 starts it first checks to see if a flag has been set, as indicated by step 300. When a flag is set, this indicates that another related operation is currently running and the data extraction updater 114 should wait until the flag is removed or deleted. If an indicator is set, then step 312 is invoked, and the application checks to see if the indicator is false. To do this, step 312 checks, for example, if the indicator has been set for an extended time interval, which may be a predetermined length of time. One of ordinary skill in the art will appreciate that such a time interval can vary in its length, though it is preferable that the time interval is longer than the time it would take to run the update or replace software routines. If the indicator is valid (e.g., it has not been set for a time interval longer than a predetermined time interval), then step 314 is invoked to wait for a predetermined amount of time before proceeding to step 300 to check if the flag is still set. Again, one of ordinary skill in the art will appreciate that such a time interval can vary in its length. However, if the indicator is invalid (e.g., it has been set longer than the predetermined time interval), then step 310 is invoked, and the indicator is removed or deleted before step 300 is invoked. This operation of checking for a flag is similar to that which is discussed above in reference to the beginning steps to the data extraction routine 110 referenced in FIG. 2.

If no flag is found at step 300, step 302 creates one to ensure other applications do not start while it is running. Next, step 304 retrieves the most recent version file of the data extraction routine 110 from the database 116. One of ordinary skill in the art will appreciate that the version file can be retrieved from various data storage locations. The version file (referred to as “tpclient.exe production software version” file in FIG. 3) is a text file that contains numbers which equate to the current production software version of the data extraction routine file. For example, if the version file specifies “1.01,” then the current data extraction routine production software version is 1.01.

Next, step 306 reads the data extraction routine local software version which is stored in a database 116, and if the production version is higher (i.e., newer) than the local version, then step 308 is invoked, and the application downloads the latest version of the data extraction routine 110 from the CMC 120 and stores it to the database 116, and if required, renames the latest version, such as “tpclient_new.exe.”. If the production version is the same as what is used currently by the local computer or is an older version, then the application does not perform a download. In an alternative embodiment of the present invention the data extraction updater can use the same network 118 to retrieve new updated data extraction routines for storage in the database 116 or any other alternative data storage location (e.g., local security system database 122).

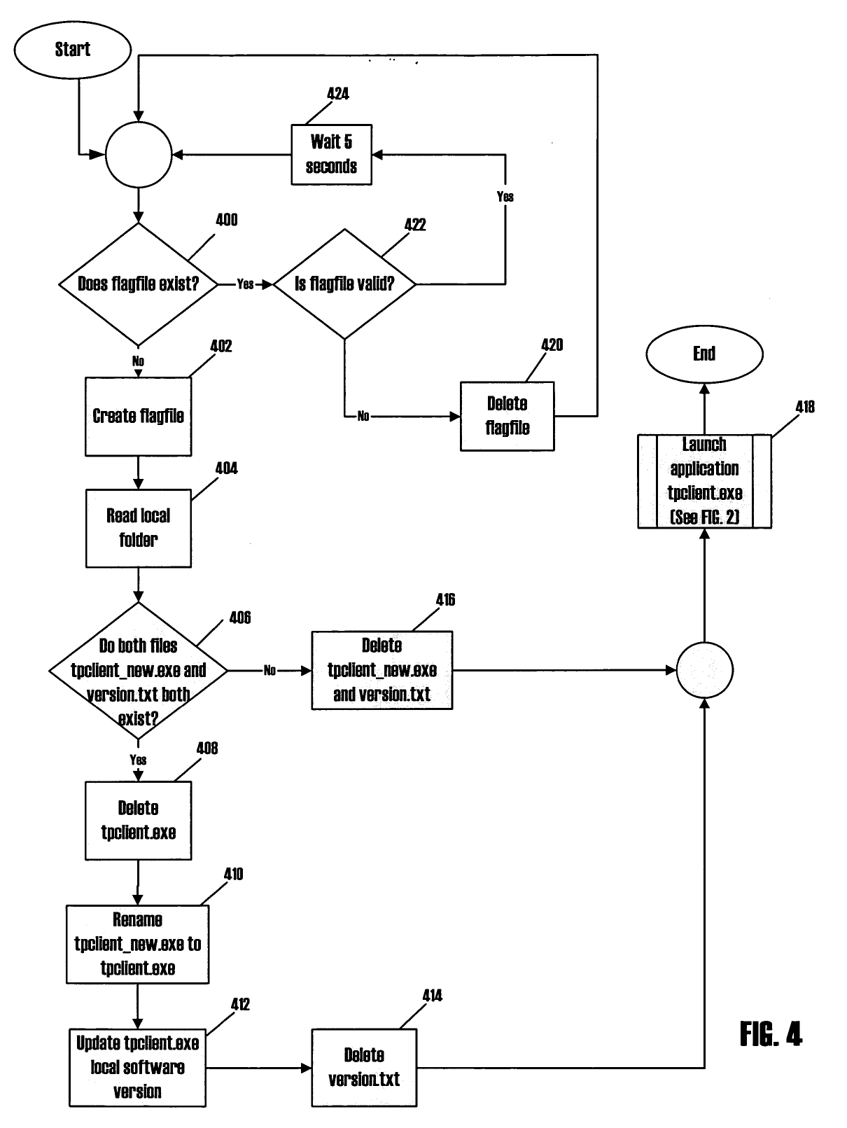

FIG. 4 is a flow chart of the data extraction replacer 112 in accordance with an exemplary embodiment of the present invention. The data extraction replacer 112 may be started by the data extraction routine 110 when a new version of the data extraction routine 110 has been downloaded by the data extraction updater 114 and has been detected in the reading of a local folder as discussed above in step 204 of the data extraction routine (shown in FIG. 2). Like both the data extraction routine 110 and the data extraction updater 114 discussed above, when the data extraction replacer 112 starts it initially checks to see if a flag has been set indicating that another operation is currently running and the data extraction replacer 112 should wait until the flag is removed or deleted, as indicated by step 400. When a flag is set, it indicates that another related operation is currently running and the data extraction replacer 112 should wait until the flag is removed or deleted. If an indicator is set, then step 422 is invoked, and the application checks to see if the indicator is false. To do this, step 422 checks if the indicator has been set for an extended time interval which may be a predetermined length of time. One of ordinary skill in the art will appreciate that such a time interval can vary in its length, though it is preferable that the time interval is longer than the time it would take to run the update or replace software routines. If the indicator is valid (e.g., it has not been set for the predetermined time interval longer than allotted), then step 424 is invoked to wait for a certain amount of time before proceeding to step 400 to check if the flag is still set. Again, one of ordinary skill in the art will appreciate that such a time interval can vary in its length. However, if the indicator is invalid (e.g., it has been set longer than the predetermined time), then step 420 is invoked, and the indicator is removed or deleted before step 400 is invoked. This flag-checking operation is discussed above in reference to the functioning of the data extraction updater 114 performing the same operation in FIG. 3.

If no flag is found, step 402 creates one to make sure other applications do not start while it is running. After creating a flag, step 404 is invoked to read a local folder located in a database 116. Next, step 406 checks that both the new data extraction routine (referred to as “tpclient_new.exe” in FIG. 4) and the version file exist. If they do not, then step 416 is invoked to delete the either the existing version file or tpclient_new.exe file (if either are there), and the data extraction routine 110 is resumed by step 418. However, if they both exist, then step 408 deletes the current data extraction routine 110, step 410 renames the new version of the data extraction routine downloaded by the data extraction updater 114 (e.g., renames “tpclient_new.exe” to “tpclient.exe”), and step 412 updates the data extraction software (referred to as “tpclient.exe” in FIG. 4) with the version previously downloaded by the data extraction updater 114 by installing the new data extraction routine. Next step 414 deletes the local version file and proceeds to step 418, which restarts the new version of the data extractor routine 110 and ends.

One of ordinary skill in the art will appreciate that the data extraction routine 110, data extraction replacer 112, and data extraction updater 114 may be integrated with one another as opposed to being three separate routines. Moreover, one of ordinary skill in the art will appreciate that both the data extraction replacer 112 and the data extraction updater 114 themselves can be replaced or updated with the use of the CMC 120 the same way the data extraction routine 110 can and is described as above. In addition, the data extraction routine 110, data extraction replacer 112, and data extraction updater 114, do not need to be run on a local computer 108 at a customer premise 124, but can be integrated and implemented on the security guard docking stations 104, or portable devices carried by security guards such as the security guard wand devices 102 themselves or other devices (e.g., radios, PDA's, etc.).

Accordingly, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for extracting data from a plurality of local security systems for centralized monitoring, comprising the steps of:
storing current security tour data from a security wand in a local security system database;
comparing the current security tour data to previously collected security tour data;
automatically generating a tour data file for transmission to a central monitoring center if the current security tour data has not previously been sent to the centralized monitoring center; and
automatically transmitting the tour data file to the centralized monitoring center.

2. The method of claim 1, wherein automatically transmitting the tour data file comprises transmitting the tour data file by FTP.

3. The method of claim 1, further comprising the steps of:
determining if a new version of a security tour data extraction routine is available at a central monitoring station;
retrieving the new version of the security tour data extraction routine exists from the central monitoring station;
storing the new version of the security tour data extraction routine in a local database;
subsequently searching the local database for the new versions of the security tour data extraction routine;
upon detecting the new version of the security tour data extraction routine in the local database, replacing a current version of a data extraction routine operating with the new version of the security tour data extraction routine.

4. The method of claim 3, further comprising renaming the new version of the security tour data extraction routine to the name of the current version of the data extracting routine.

5. The method of claim 3, further comprising comparing a first version indicator associated with the current version with a second version indicator associated with the new version.

6. The method of claim 3, further comprising initially determining if a flag has been set in association with a data extraction routine.

7. The method of claim 6, further comprising the setting of a flag is no flag is set.

8. A tour guard security system at a local facility that is in communications with a central monitoring system, comprising:
a security guard wand;
a security guard docking station, wherein the security guard wand communicates security tour data to the security guard docking station, and wherein the security tour data is stored to a security system database in communication with the security guard docking station;
a local computer in communicates with the security system database, wherein the local computer includes a memory in which is stored (a) a data extraction routine that retrieves the security tour data from the security system database and automatically uploads the security tour data to a server, wherein the server transmits the security tour data to the central monitoring center, (b) an updater routine that automatically checks the central monitoring center for a new version of the data extraction routine, wherein the updater routine downloads the new version of the data extraction routine and stores it in a local computer database; and (c) a replacer routine that automatically replaces the data extraction routine with the new version when the new version is stored in the local computer database.

9. The tour guard system of claim 8, wherein the security system database and the memory of the local computer are co-resident on a single device.

10. The tour guard system of claim 8, wherein the security system database is remotely disposed with regard to the memory of the local computer.
